(19) United States
(12) Patent Application Publication
(10) Pub. No.: US 2016/0187549 A1
(43) Pub. Date: Jun. 30, 2016

(54) POLARIZING FILM, METHOD OF MANUFACTURING THE SAME, AND DISPLAY DEVICE

(71) Applicants: SAMSUNG ELECTRONICS CO., LTD., Suwon-si (KR); SAMSUNG SDI CO., LTD., Yongin-si (KR)

(72) Inventors: Beom Seok KIM, Seoul (KR); Feifei FANG, Suwon-si (KR); Jong Hoon WON, Yongin-si (KR); Seong-Jun YOON, Yongin-si (KR); Dong Yun LEE, Suwon-si (KR); Boreum JEONG, Daejeon (KR); Myung Sup JUNG, Seongnam-si (KR)

(21) Appl. No.: 14/725,228

(22) Filed: May 29, 2015

(30) Foreign Application Priority Data
Dec. 31, 2014 (KR) 10-2014-0195864

(51) Int. Cl. G02B 5/30; B29D 11/00

(52) U.S. Cl. CPC G02B 5/305; B29D 11/00644; B29K 2101/12

(57) ABSTRACT

A polarizing film includes a core layer including a first hydrophobic polymer and a dichroic dye, and a first skin layer and a second skin layer disposed at respective sides of the core layer and including a second hydrophobic polymer, wherein the first skin layer, the core layer, and the second skin layer are integrated.

### CROSS-REFERENCE TO RELATED APPLICATION

This application claims priority to Korean Patent Application No. 10-2014-0195864, filed in the Korean Intellectual Property Office on Dec. 31, 2014, and all the benefits accruing therefrom under 35 U.S.C. §119, the content of which is incorporated herein in its entirety by reference.

### BACKGROUND

1. Field

A polarizing film, a method of manufacturing the same, and a display device are disclosed.

2. Description of the Related Art

A display device such as a liquid crystal display (LCD) and an organic light emitting diode (OLED) includes a polarizing plate attached to the outside of a display panel. The polarizing plate only transmits light of a specific wavelength and absorbs or reflects light of any other wavelength, therebycontrolling the direction of incident light on the display panel or light emitted from the display panel.

The polarizing plate generally includes a polarizer and a protective layer for the polarizer. The polarizer may be formed of, for example, polyvinyl alcohol, and the protective layer may be formed of, for example, triacetyl cellulose (TAC).

However, the process of fabrication of the polarizing plate including the polarizer and the protective layer is not only complicated and expensive, but also results in production of a thick polarizing plate which leads to an increased thickness of a display device.

Accordingly, a method of manufacturing a polarizing film without a protective layer by melt-elongating a polymer and a dichroic dye has been actively researched. However, during a film manufacturing process, an extension roll may be contaminated due to migration of a dichroic dye, or a dichroic dye may bleed out of the film during storage of a wound sheet before extension, which may cause inferior appearance of the film.

### SUMMARY

An embodiment provides a polarizing film that does not cause roll contamination due to migration of a dichroic dye during extension, and having improved storage stability.

Another embodiment provides a display device including the polarizing film.

Yet another embodiment provides a method of manufacturing the polarizing film.

According to an embodiment, a polarizing film includes a core layer including a first hydrophobic polymer and a dichroic dye, and a first skin layer and a second skin layer disposed at first and second sides of the core layer, and including a second hydrophobic polymer, wherein the first skin layer, the core layer, and the second skin layer are integrated.

The first hydrophobic polymer and the second hydrophobic polymer may be the same as, or different from, each other, and may be polyolefin, polyamide, polyester, a poly(meth)acrylic, polystyrene, a copolymer thereof, or a combination thereof.

The first hydrophobic polymer and the second hydrophobic polymer may include polyethylene (PE), polypropylene (PP), polyethylene terephthalate (PET), polybutylene terephthalate (PBT), polyethylene terephthalate glycol (PETG), polyethylene naphthalate (PEN), nylon, a copolymer thereof, or a combination thereof.

The dichroic dye may be included in an amount of about 0.1 to about 10 parts by weight, specifically about 0.5 to about 5 parts by weight, based on 100 parts by weight of the first hydrophobic polymer.

A ratio of the sum of the thicknesses of the first skin layer and the second skin layer, and the thickness of the core layer, may be about 1:4 to about 4:1.

According to another embodiment, a method of manufacturing a polarizing film includes melt-blending a first hydrophobic polymer and a dichroic dye to prepare a composition for a core layer, melting a second hydrophobic polymer to prepare a composition for a skin layer, and co-extruding the composition for a core layer with the composition for a skin layer at both sides of the composition for a core layer.

According to another embodiment, a display device including the polarizing film is provided.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a polarizing film according to an embodiment;

FIG. 2 is a cross-sectional view of a liquid crystal display (LCD) according to an embodiment; and

FIG. 3 is a cross-sectional view of an organic light emitting diode (OLED) display according to an embodiment.

### DETAILED DESCRIPTION

Exemplary embodiments will hereinafter be described in detail, and may be easily performed by those who have common knowledge in the related art. However, this disclosure may be embodied in many different forms, and is not construed as limited to the exemplary embodiments set forth herein; rather, these embodiments are provided so that this disclosure will fully convey the scope of the disclosure to those skilled in the art. Thus, in some exemplary embodiments, well known technologies are not specifically explained to avoid ambiguous understanding of the present inventive concept. Accordingly, the exemplary embodiments are merely described below, by referring to the figures, to explain aspects of the present inventive concept.

Expressions such as “at least one of,” when preceding a list of elements, modify the entire list of elements and do not modify the individual elements of the list. Unless otherwise defined, all terms used in the specification (including technical and scientific terms) may be used with meanings commonly understood by a person having ordinary knowledge in the art to which this invention belongs. Further, unless explicitly defined to the contrary, the terms defined in a generally-used dictionary should be interpreted as having a meaning that is consistent with their meaning in the context of the relevant art and the present disclosure, and are not ideally or excessively interpreted. In addition, unless explicitly described to the contrary, the word “comprise” and variations such as “comprises” or “comprising”, and the word “include” and variations such as “includes” or “including”, when used in this specification, specify the presence of stated features, regions, integers, steps, operations, elements, and/or components, but do not preclude the presence or addition of one or more other features, regions, integers, steps, operations, elements, components, and/or groups thereof. Therefore, the above words will be understood to imply the inclusion of stated elements but not the exclusion of any other elements.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As stated above, unless specifically described to the contrary, a singular form includes a plural form, and is not to be construed as limited to the exemplary embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

As used herein, when a definition is not otherwise provided, the term “substituted” refers to a group substituted with at least one substituent selected from a C1 to C10 alkyl group, a C2 to C20 alkenyl group, a C2 to C20 alkynyl group, and a combination thereof, in place of at least one hydrogen of a functional group or a compound.

As used herein, when a definition is not otherwise provided, the term “alkyl group” may refer to a group derived from a straight or branched chain saturated aliphatic hydrocarbon having the specified number of carbon atoms and having a valence of at least one.

As used herein, when a definition is not otherwise provided, the term “alkoxy group” may refer to “alkyl-O—”, wherein the term “alkyl” has the same meaning as described above.

As used herein, when a definition is not otherwise provided, the term “alkenyl group” may refer to a straight or branched chain, monovalent hydrocarbon group having at least one carbon-carbon double bond.

As used herein, when a definition is not otherwise provided, the term “alkynyl group” may refer to a straight or branched chain, monovalent hydrocarbon group having at least one carbon-carbon triple bond.

Hereinafter, a polarizing film according to an embodiment is described with reference to the drawings.

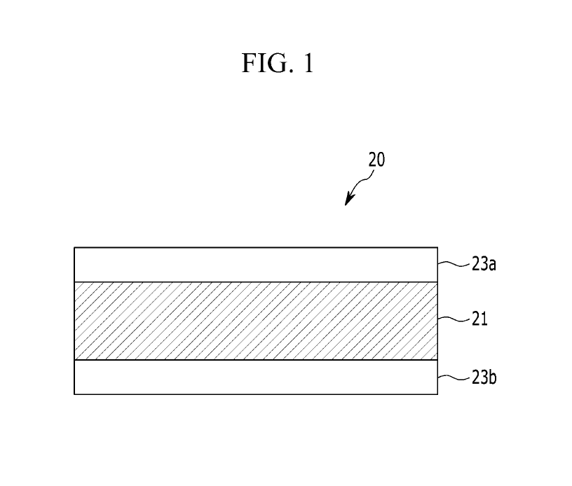

FIG. 1 is a schematic view of a polarizing film according to an embodiment.

Referring to FIG. 1, a polarizing film includes a core layer 21 including a first hydrophobic polymer and a dichroic dye, and a first skin layer 23a and a second skin layer 23b disposed at respective sides of the core layer 21 and including a second hydrophobic polymer, wherein the first skin layer 23a, the core layer 21, and second skin layer 23b are integrated.

The first hydrophobic polymer and the second hydrophobic polymer may be the same as or different from each other, and may be, for example, a polyolefin such as polyethylene (PE), polypropylene (PP) and a copolymer thereof; a polyamide resin such as nylon and an aromatic polyamide; a polyester resin such as polyethylene terephthalate (PET), polybutylene terephthalate (PBT), polyethylene terephthalate glycol (PETG) and polyethylene naphthalate (PEN); a poly(meth)acrylic such as polymethyl(meth)acrylate; a polystyrene such as polystyrene (PS) and an acrylonitrile-styrene copolymer; a polycarbonate; a polyvinylchloride-based; a polyimide; a sulfone; a polyethersulfone; a polyether-etherketone; a polyphenylene sulfide; a vinylidene chloride; a vinylbutyral; an arylate; a polyoxymethylene; an epoxy resin; a copolymer thereof; or a combination thereof.

In one embodiment, the first hydrophobic polymer and the second hydrophobic polymer may be, for example, a polyolefin, a polyamide, a polyester, a poly(meth)acrylic, a polystyrene, a copolymer thereof, or a combination thereof, for example polyethylene (PE), polypropylene (PP), polyethylene terephthalate (PET), polybutylene terephthalate (PBT), polyethylene terephthalate glycol (PETG), polyethylene naphthalate (PEN), nylon(nylon), a copolymer thereof, or a combination thereof.

In another embodiment, the first hydrophobic polymer and the second hydrophobic polymer may be a mixture of at least two selected from polyethylene (PE), polypropylene (PP), and a copolymer of polyethylene and polypropylene (PE-PP), and in another embodiment, a mixture of polypropylene (PP) and a polyethylene-polypropylene copolymer (PE-PP).

In this case, the polypropylene (PP) and the polyethylene-polypropylene copolymer (PE-PP) may be included in a weight ratio of about 1:9 to about 9:1, for example about 7:3 to about 3:7, about 4:6 to about 6:4, or about 5:5. When the polypropylene (PP) and the polyethylene-polypropylene copolymer (PE-PP) are included within these ranges, haze characteristics of a polarizing film may be improved while maintaining excellent mechanical strength.

When the first hydrophobic polymer and the second hydrophobic polymer are a mixture of polyethylene and a polyethylene and polypropylene (PE-PP) copolymer, a content of an ethylene group may be about 1 to about 50 percent by weight (wt %), for example about 1 wt % to about 35 wt % based on the total amount of the polymer. When the ethylene group content of the polyethylene-polypropylene copolymer (PE-PP) is within these ranges, phase-separation of the polypropylene and the polyethylene-polypropylene copolymer (PE-PP) may be prevented or suppressed. In addition, the polyethylene-polypropylene copolymer (PE-PP) may increase an elongation rate during the process of elongation, and may have excellent light transmittance and orientation, thus improving polarization characteristics.

The first hydrophobic polymer and the second hydrophobic polymer may have a melt flow index (MFI) of about 1 gram(s) per 10 minutes (g/10 min) to about 15 g/10 min, in an embodiment about 3 g/10 min to about 12 g/10 min, in another embodiment about 5 g/10 min to about 10 g/10 min. Herein, the melt flow index shows the amount of a polymer in a melt state flowing per 10 minutes, and relates to viscosity of the polymer in a melted state. In other words, when the melt flow index is lower, the polymer has higher viscosity, and when the melt flow index is higher, the polymer has lower viscosity. When the melt flow index is within the above ranges, properties of a final product as well as its workability may be effectively improved.

The polypropylene (PP) may have a melt flow index ranging from about 2 g/10 min to about 10 g/10 min, and the polyethylene-polypropylene copolymer (PE-PP) may have a melt flow index ranging from about 5 g/10 min to about 15 g/10 min. When the polypropylene (PP) and the polyethylene-polypropylene copolymer (PE-PP) have a melt flow index within these ranges, properties of a final product, as well as its workability may be effectively improved.

A melt flow index difference between the first hydrophobic polymer and the second hydrophobic polymer may range from about 0 g/10 min to about 10 g/10 min. In this case, interface characteristics between the core layer 21 and the first and second skin layers 23a and 23b are improved and workability is improved.

The dichroic dye is dispersed into the first hydrophobic polymer, and is aligned in the elongation direction of the first hydrophobic polymer. The dichroic dye is a material that transmits one perpendicular polarization component of two perpendicular polarization components in a predetermined wavelength region.

Such a dichroic dye may include, for example, an azo-based compound, an anthraquinone-based compound, a phthalocyanine-based compound, an azomethine-based compound, an indigoid or thioindigoid-based compound, a merocyanine-based compound, a 1,3-bis(dicyanomethylene)indan-based compound, an azulene-based compound, a quinophthalonic-based compound, a triphenodioxazine-based compound, an indolo[2,3,b]quinoxaline-based compound, an imidazo[1,2-b]-1,2,4 triazines-based compound, a tetrazine-based compound, a benzo-based compound, a naphtoquinone-based compound, or a compound having a combined molecular backbone of the foregoing compounds.

The dichroic dye may be included in an amount of about 0.1 to about 10 parts by weight, for example about 0.5 to about 5 parts by weight, based on 100 parts by weight of the first hydrophobic polymer. When the dichroic dye is included within the above ranges, sufficient polarization characteristics may be obtained without deteriorating transmittance of a polarizing film.

The polarizing film 20 may have polarizing efficiency of greater than or equal to about 90%, for example about 93 to about 99.9%. The polarizing film 20 may have excellent polarizing efficiency at high light transmittance of greater than or equal to about 38%, for example greater than or equal to about 40%. Herein, the polarizing efficiency is obtained by the following Equation 1.

PE (%)=[(T_{∥}−T_{⊥})/(T_{∥}−T_{⊥})]^{1/2}□100 Equation 1

In the Equation 1,

PE denotes polarizing efficiency,

T_{∥} is transmittance of light entering parallel to the transmissive axis of a polarizing film, and

T_{⊥} is transmittance of light entering perpendicular to the transmissive axis of the polarizing film.

The polarizing film 20 may have haze ranging from greater than 0 to less than or equal to about 5%, for example about 0.5% to about 3.5%, for another example about 0.5% to about 2.5%. When it has haze within the range, transmittance increases and excellent optical properties may be obtained.

The ratio of the sum of the thicknesses of the first skin layer 23a and the second skin layer 23b, and the thickness of the core layer 21, may be about 1:4 to about 4:1, for example about 1:1 to about 1:2, but is not limited thereto. The ratio of thickness of the first skin layer 23a or the second skin layer 23b and the core layer 21 may range from about 1:5 to about 5:1, for example about 1:1 to about 2:1. When the ratio of the sum of the thicknesses of the first skin layer 23a and the second skin layer 23b, and the thickness of the core layer 21, is within the range, migration of a dye may be effectively prevented and excellent optical properties (light transmittance, polarizing efficiency etc.) may be ensured.

In the polarizing film 20, the thickness of the core layer 21 has no particular limit, but may be adjusted depending on concentration of a dichroic dye, and for example may be in a range of about 0.4 to about 125 microns.

In the polarizing film 20, the first skin layer 23a and the second skin layer 23b have no particular limit in their thicknesses, but may respectively be in a range of about 2 to about 25 microns. Within the range, light transmittance and polarizing efficiency of the polarizing film 20 may be easily adjusted, and thinness of the polarizing film 20 may be realized.

The polarizing film 20 includes the integrated first skin layer 23a, core layer 21, and second skin layer 23b. Specifically, the polarizing film 20 may be manufactured by melt-blending the first hydrophobic polymer and the dichroic dye to prepare a composition for a core layer, melting a second hydrophobic polymer to prepare a composition for a skin layer, and co-extruding the composition for a core layer with the composition for a skin layer along respective sides of the composition for a core layer.

The composition for a core layer may be prepared by melt-blending the first hydrophobic polymer and the dichroic dye at a temperature of greater than or equal to the melting point (Tm) of the first hydrophobic polymer.

The composition for a core layer may be prepared by melt-blending the first hydrophobic polymer and the dichroic dye in a solid state, and may have a solid content of greater than or equal to about 90 wt %, and for example, may not include a solvent.

The composition for a skin layer may be prepared by melt-blending the second hydrophobic polymer at a temperature of greater than or equal to the melting point (Tm) of the second hydrophobic polymer.

The composition for a core layer and the composition for a skin layer are extruded through a co-extruder and manufactured into a sheet, and the sheet may be elongated in a uniaxial direction to manufacture the polarizing film 20.

In other words, the co-extruder consists of first and second extruders, and the first extruder is supplied with the composition for a core layer, while the second extruder is supplied with the composition for a skin layer, so that the first/second skin layers 23a and 23b may be present on respective surfaces of the core layer 21.

Herein, the thicknesses of the core layer 21 and the first and second skin layers 23a and 23b may be controlled by adjusting the screw speed of the co-extruder. In other words, the thicknesses of the core layer 21 and the first/second skin layers 23a and 23b may be controlled by adjusting screw speeds of the first extruder supplied with the composition for a core layer and the second extruder supplied with the composition for a skin layer in a ratio range of about 1:4 to about 4:1, and specifically, about 1:1 to about 1:2.

Then, the sheet formed through the co-extruder is elongated in a uniaxial direction, manufacturing the polarizing film 20. The polarizing film 20 obtained after the co-extrusion process may have a united structure in which the core layer 21 is not detached from the first and second skin layers 23a and 23b at the interface thereof. In addition, since the first and second skin layers 23a and 23b are present on the surface of the core layer 21 in the co-extrusion process, a dichroic dye is not exposed to the surface of the sheet before the elongation when wound and stored, increasing storage stability of the sheet and preventing the dichroic dye from contaminating a roll during the elongation.

The elongation in a uniaxial direction may be performed at a temperature ranging from about 30 to about 200° C. at an elongation rate ranging from about 400% to about 1,200%. The elongation rate refers to a ratio of the length of the sheet after the elongation to the length of the sheet before the elongation of the sheet, and numerically expresses the elongation extent of the sheet after uniaxial elongation.

The polarizing film 20 may be applied to various display devices.

The display device may be a liquid crystal display (LCD).

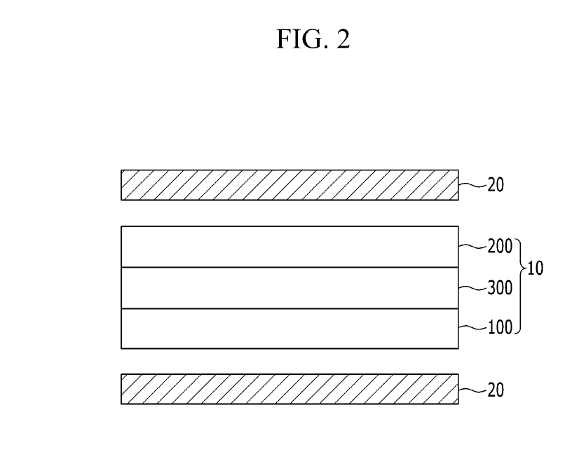

FIG. 2 is a cross-sectional view showing a liquid crystal display (LCD) according to an embodiment.

Referring to FIG. 2, the LCD according to one embodiment includes a liquid crystal display panel 10, and a polarizing film 20 disposed on both the lower part and the upper part of the liquid crystal display panel 10.

The liquid crystal display panel 10 may be a twist nematic (TN) mode panel, a patterned vertical alignment (PVA) mode panel, an in-plane switching (IPS) mode panel, an optically compensated bend (OCB) mode panel, and the like.

The liquid crystal display panel 10 includes a first display panel 100, a second display panel 200, and a liquid crystal layer 300 interposed between the first display panel 100 and the second display panel 200.

The first display panel 100 may include, for example, a thin film transistor (not shown) formed on a substrate (not shown), and a first electric field generating electrode (not shown) connected thereto. The second display panel 200 may include, for example, a color filter (not shown) formed on the substrate and a second electric field generating electrode (not shown). However, it is not limited thereto, and the color filter may be included in the first display plate 100, while both the first electric field generating electrode and the second electric field generating electrode may be disposed in the first display plate 100.

The liquid crystal layer 300 may include a plurality of liquid crystal molecules. The liquid crystal molecules may have positive or negative dielectric anisotropy. When the liquid crystal molecules have positive dielectric anisotropy, the long axes thereof may be aligned substantially parallel to the surface of the first display plate 100 and the second display plate 200 when an electric field is not applied, and may be aligned substantially perpendicular to the surface of the first display plate 100 and the second display plate 200 when an electric field is applied. On the contrary, when the liquid crystal molecules have negative dielectric anisotropy, the long axes thereof may be aligned substantially perpendicular to the surface of the first display plate 100 and the second display plate 200 when an electric field is not applied, and may be aligned substantially parallel to the surface of the first display plate 100 and the second display plate 200 when an electric field is applied.

The polarizing film 20 is disposed on the outside of the liquid crystal display panel 10. Although the polarizing film 20 is shown to be disposed on the upper part and lower part of the liquid crystal display panel 10 in the drawing, in another embodiment, the polarizing film 20 may be formed on only one of either the upper part or the lower part of the liquid crystal display panel 10.

The polarizing film 20 includes a polymer and a dichroic dye as in the other layers described above.

The display device may be an organic light emitting diode (OLED) display.

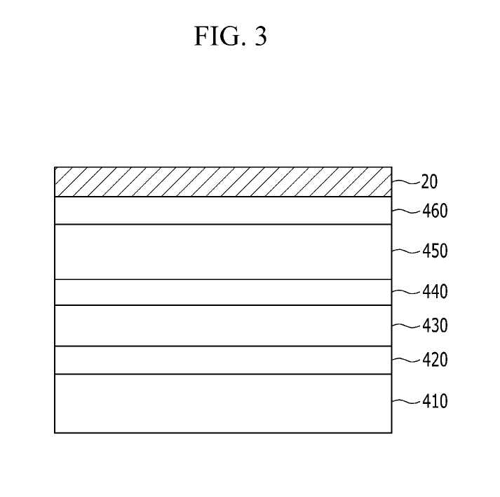

FIG. 3 is a cross-sectional view showing an organic light emitting diode (OLED) display according to an embodiment.

Referring to FIG. 3, an organic light emitting diode (OLED) display according to an embodiment includes a base substrate 410, a lower electrode 420, an organic emission layer 430, an upper electrode 440, an encapsulation substrate 450, a phase retardation film 460, and a polarizing film 20.

The base substrate 410 may be formed of glass or plastic.

Either of the lower electrode 420 or the upper electrode 440 may be an anode, while the other is a cathode. The anode is an electrode where holes are injected. It is formed of a transparent conductive material having a high work function and externally transmitting entered light, for example, indium-doped titanium oxide (ITO) or indium-doped zinc oxide (IZO). The cathode is an electrode where electrons are injected. It is formed of a conducting material having a low work function and having no influence on an organic material, which is selected from, for example, aluminum (Al), calcium (Ca), and barium (Ba).

The organic emission layer 430 includes an organic material emitting light when a voltage is applied between the lower electrode 420 and the upper electrode 440.

An auxiliary layer (not shown) may beincluded between the lower electrode 420 and the organic emission layer 430 and between the upper electrode 440 and the organic emission layer 430. The auxiliary layer may include a hole transport layer, a hole injection layer, an electron injection layer, and an electron transport layer for balancing electrons and holes.

The encapsulation substrate 450 may be made of glass, metal, or a polymer. The lower electrode 420, the organic emission layer 430, and the upper electrode 440 are sealed to prevent moisture and/or oxygen from flowing in.

The phase retardation film 460 may circularly polarize light passing through the polarizing film 20 and generate a phase difference, thus having an influence on reflection and absorption of the light. The phase retardation film 460 may be omitted in an embodiment.

The polarizing film 20 may be disposed at a light-emitting side. For example, the polarizing film 20 may be disposed outside of the base substrate 410 in a bottom emission type in which light emits from the base substrate 410, and outside of the encapsulation substrate 450 in a top emission type in which light emits from the encapsulation substrate 450.

The polarizing film 20 may play a role of a light absorption layer absorbing external light, and thus prevent display characteristic deterioration due to reflection of the external light.

Hereinafter, the present disclosure is illustrated in more detail with reference to examples. However, these examples are exemplary, and the present disclosure is not limited thereto.

### Preparation of Composition (A) for Core Layer

A composition (A) for a core layer is prepared by mixing 1 part by weight of a dichroic dye represented by the following Chemical Formulae 1 to 4 with 100 parts by weight of a polyolefin including 60 parts by weight of polypropylene (HU300, Samsung Total Petrochemicals Co., Ltd.) and 40 parts by weight of a polypropylene-ethylene copolymer (RJ581, Samsung Total Petrochemicals Co., Ltd.). Each dichroic dye is used as follows: 0.200 parts by weight of a dichroic dye represented by the following Chemical Formula 1 (yellow, λₘₐₓ=385 nanometers (nm), dichroic ratio=7.0), 0.228 parts by weight of a dichroic dye represented by the following Chemical Formula 2 (yellow, λₘₐₓ=455 nm, dichroic ratio=6.5), 0.286 parts by weight of a dichroic dye represented by the following Chemical Formula 3 (red, λₘₐₓ=555 nm, dichroic ratio=5.1), and 0.286 parts by weight of a dichroic dye represented by the following Chemical Formula 4 (blue, λₘₐₓ=600 nm, dichroic ratio=4.5).

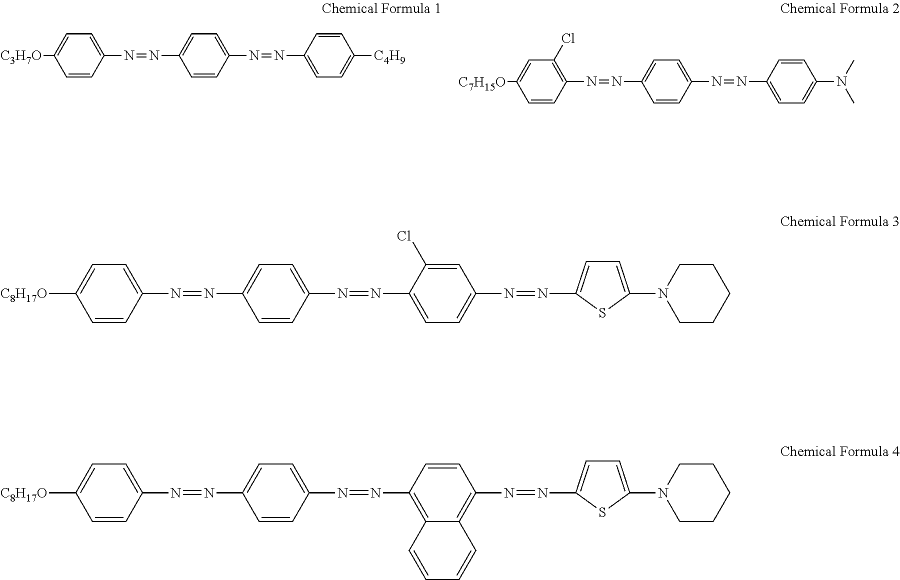

### Preparation of Composition (B) for Core Layer

A composition (B) for a core layer is prepared according to the same method as composition (A) for a core layer, except that the dichroic dyes represented by the Chemical Formulae 1 to 4 are used in the following amounts: Chemical Formula 10.400 parts by weight, Chemical Formula 2 0.456 parts by weight, Chemical Formula 3 0.572 parts by weight, and Chemical Formula 4 0.572 parts by weight (total amount: 2 parts by weight).

### Preparation of Composition (C) for Skin Layer

A composition (C) for a skin layer is prepared by mixing 60 parts by weight of polypropylene (HU300, Samsung Total Petrochemicals Co., Ltd.), and parts by weight of a polypropylene-ethylene copolymer (RJ581, Samsung Total Petrochemicals Co., Ltd.).

### Manufacture of Polarizing Film Before Extension (Sheet)

### Comparative Preparation Example 1

The composition (A) for a core layer is injected into a first extruder of a co-extruder consisting of two Collin E20T extruders, is melted, and is film-formed, manufacturing a sheet. The first extruder is set at an extrusion temperature of 230° C., a screw speed of 40 rpm, and a casting roll temperature of 80° C. in an open casting method without using a touch roll, and the sheet is manufactured to be 183 micrometers (μm) thick.

### Preparation Example 1

A sheet is manufactured by injecting the composition (A) for a core layer in a first extruder of a co-extruder consisting of two Collin E20T extruders and the composition (C) for a skin layer into a second extruder thereof, and then melting and film-forming them. The first extruder is set at an extrusion temperature of 230° C. and a screw speed of 40 rpm, and the second extruder is set at an extrusion temperature of 230° C., a screw speed of 20 rpm, and a casting roll temperature of 80° C. in an open casting method without using a touching roll, manufacturing a sheet having a thickness of 183 μm.

### Preparation Example 2

A sheet having a thickness of 259 μm is manufactured according to the method in Preparation Example 1, with the screw speed of the second extruder set at 30 rpm.

### Preparation Example 3

A sheet having a thickness of 330 μm is manufactured according to the method in Preparation Example 1, with the screw speed of the second extruder set at 40 rpm.

### Preparation Example 4

A sheet having a thickness of 330 μm is manufactured according to the method in Preparation Example 1, with HU300 (polypropylene, Samsung Total Petrochemicals Co., Ltd.) as thepolymer and the screw speed of the second extruder set at 40 rpm.

### Preparation Example 5

A sheet having a thickness of 332 μm is manufactured according to the method in Preparation Example 1, with HF351 (polypropylene, Samsung Total Petrochemicals Co., Ltd.) as the polymer and the screw speed of the second extruder set at 40 rpm.

### Preparation Example 6

A sheet having a thickness of 327 μm is manufactured according to the method in Preparation Example 1, with RP5050 (a polypropylene-ethylene copolymer, Polymirae Co., Ltd.) as the polymer and the screw speed of the second extruder set at 40 rpm.

### Preparation Example 7

A sheet having a thickness of 180 μm is manufactured according to the method in Preparation Example 1, with composition (B) injected into the first extruder for a core layer as in Preparation Example 2, and the screw speed of the first extruder set at 20 rpm.

### Manufacture of Polarizing Film

Each polarizing film used in Comparative Example 1 and Examples 1 to 7 is manufactured by cutting the sheets of Comparative Preparation Example 1 and Preparation Examples 1 to 7, respectively, to a size of 45 mm×30 mm, and then 900% elongating in a uniaxial direction at 120° C. using a tensile tester made by Instron.

### Migration of Dye

(1) Evaluation by Naked Eye

Prior to elongation, the surfaces of the sheets prepared according to Comparative Preparation Example 1 and Preparation Examples 1 to 7 are examined with the naked eye after allowing the sheets to stand at room temperature for 7 days. The sheet surfaces show high glossiness directly after extruding and film-forming, but show deteriorated glossiness and develop varying degrees of cloudiness observable with the naked eye after storing at room temperature, which may be due to the relative degree of migration of the dye onto the surface of each sheet. The relative degrees of cloudiness are evaluated as follows, and the results are provided in Table 1.

5: No cloudiness.

4: Cloudiness occurs in an area of less than 25% of the sheet surface area.

3: Cloudiness occurs in an area of greater than or equal to 25% and less than 50% of the sheet surface area.

2: Cloudiness occurs in an area of greater than or equal to 50% and less than 75% of the sheet surface area.

1: Cloudiness occurs in an area of greater than or equal to 75% of the sheet surface area.

(2) Adhesive Tape Test

The initial absorption spectra (A₁) of the unelongated sheets prepared according to Comparative Preparation Example 1 and Preparation Examples 1 to 7 are measured using a UV-VIS Spectrophotometer (V-7100). Strips of transparent tape (Scotch™ Tape, Cat. 122A, 3M) are attached to the surfaces of unelongated sheets, respectively. The sheets with tape strips attached are then allowed to stand in an 85° C. oven for 24 hours. Then, the transparent tape strips are detached from the sheet surfaces, and the absorption spectra (A₂) of the tape strips are measured, using the same device as above. A difference between these two spectra (A₂-A₁) is an absorption spectrum (A₃) of a dye transferred from the sheet to the adhesion layer on the transparent tape while allowed to stand in an oven.

The absorbance (A₃) is evaluated and compared at each maximum absorption wavelength of the dyes of Chemical Formulae 1-4, and the results are provided in Table 1.

TABLE 1

| | Naked eye | Absorbance (A₃) | | | |
|---|---|---|---|---|---|
| | Cloudi- | 385 | 455 | 555 | 600 |
| | ness | nm | nm | nm | nm |
| Comparative | 1 | 0.0352 | 0.0126 | 0.0026 | 0.0023 |
| Preparation Example 1 | | | | | |
| Preparation Example 1 | 4 | 0.0164 | 0.0065 | 0.0007 | 0.0002 |
| Preparation Example 2 | 5 | 0.0062 | 0.0023 | 0.0005 | 0.0002 |
| Preparation Example 3 | 5 | 0.0032 | 0.0009 | 0.0004 | 0.0003 |
| Preparation Example 4 | 5 | 0.0011 | 0.0005 | 0.0006 | 0.0007 |
| Preparation Example 5 | 5 | 0.0034 | 0.0011 | 0.0007 | 0.0010 |
| Preparation Example 6 | 5 | 0.0099 | 0.0037 | 0.0002 | 0.0004 |
| Preparation Example 7 | 4 | 0.0175 | 0.0070 | 0.0008 | 0.0003 |

Referring to Table 1, the sheets having a three-layered structure of first skin layer/core layer/second skin layer according to Preparation Examples 1 to 7 demonstrate lower cloudiness and lower absorbance (A₃) than those of the sheet having a monolayer structure prepared according to Comparative Preparation Example 1. The posited mechanism for improvement is that the first and second skin layers prevent migration of a dichroic dye present in a core layer. This posited mechanism of action is merely provided as an aid to discussion of results, and the scope of protection of the inventive concept(s) here demonstrated is not to be limited by any theory of action herein provided.

### Optical Properties (Light Transmittance and Polarizing Efficiency) of Polarizing Film

Light transmittance (Ts) and polarizing efficiency (PE) of the polarizing films according to Comparative Example 1, Example 3, and Example 7 are measured, and the results are shown in the following Table 2. The light transmittance is obtained by measuring: light transmittance of a polarizing film of light parallel to a transmittance axis of the polarizing film; and light transmittance of the polarizing film of light perpendicular to the transmittance axis of the polarizing film, using a UV-VIS spectrophotometer (V-7100, JASCO).

The polarizing efficiency is calculated using the measured light transmittance values obtained above, and Equation 1 (introduced above, and restated here for convenience).

PE (%)=[(T_{∥}−T_{⊥})/(T_{∥}−T_{⊥})]^{1/2}□100 Equation 1

In Equation 1,

PE denotes polarizing efficiency,

T_{∥} is transmittance of light entering parallel to the transmissive axis of a polarizing film, and

T_{⊥} is transmittance of light entering perpendicular to the transmissive axis of the polarizing film.

The light transmittance and polarizing efficiency are shown in the following Table 2.

TABLE 2

| | Thickness of | Light | Polarizing |
|---|---|---|---|
| | polarizing film | transmittance | efficiency |
| | (μm) | (%) | (%) |
| Comparative Example 1 | 23 | 40.49 | 98.80 |
| Example 3 | 41.3 | 40.50 | 98.75 |
| Example 7 | 22.0 | 40.47 | 98.71 |

Referring to Table 2, the polarizing film having a single layer according to Comparative Example 1 shows similar polarizing efficiency at the same light transmittance to the polarizing films having three layers of the first skin layer/the core layer/the second skin layer according to Example 3 and Example 7. From these results, the polarization characteristics are not deteriorated in the polarizing films of Examples 3 and 7 which have the additional first skin layer and second skin layer, as compared to the single layer polarizing film of Comparative Example 1.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A polarizing film comprising:
a core layer comprising a first hydrophobic polymer and a dichroic dye; and
a first skin layer and a second skin layer disposed at respective sides of the core layer and comprising a second hydrophobic polymer,
wherein the first skin layer, the core layer, and the second skin layer are integrated.

2. The polarizing film of claim 1, wherein the first hydrophobic polymer and the second hydrophobic polymer are the same as, or different from, each other.

3. The polarizing film of claim 1, wherein the first hydrophobic polymer and the second hydrophobic polymer comprise polyolefin, polyamide, polyester, poly(meth)acrylic, polystyrene, a copolymer thereof, or a combination thereof.

4. The polarizing film of claim 1, wherein the first hydrophobic polymer and the second hydrophobic polymer comprise polyethylene, polypropylene, polyethylene terephthalate, polybutylene terephthalate, polyethylene terephthalate glycol, polyethylene naphthalate, nylon, a copolymer thereof, or a combination thereof.

5. The polarizing film of claim 1, wherein the dichroic dye is present in an amount of about 0.1 to about 10 parts by weight based on 100 parts by weight of the first hydrophobic polymer.

6. The polarizing film of claim 5, wherein the dichroic dye is present in an amount of about 0.5 to about 5 parts by weight based on 100 parts by weight of the first hydrophobic polymer.

7. The polarizing film of claim 1, wherein a ratio of the sum of the thicknesses of the first skin layer and the second skin layer, to the thickness of the core layer, is about 1:4 to about 4:1.

8. A method of manufacturing a polarizing film, comprising:
melt-blending a first hydrophobic polymer and a dichroic dye to prepare a composition for a core layer;
melting a second hydrophobic polymer to prepare a composition for a skin layer; and
co-extruding the composition for a core layer with the composition for a skin layer at both sides of the composition for a core layer.

9. The method of claim 8, wherein the first hydrophobic polymer and the second hydrophobic polymer are the same as, or different from, each other.

10. The method of claim 8, wherein the first hydrophobic polymer and the second hydrophobic polymer comprise polyolefin, polyamide, polyester, poly(meth)acrylic, polystyrene, a copolymer thereof, or a combination thereof.

11. The method of claim 8, wherein the first hydrophobic polymer and the second hydrophobic polymer comprise polyethylene, polypropylene, polyethylene terephthalate, polybutylene terephthalate, polyethylene terephthalate glycol, polyethylene naphthalate, nylon, a copolymer thereof, or a combination thereof.

12. The method of claim 8, wherein the dichroic dye is present in an amount of about 0.1 to about 10 parts by weight based on 100 parts by weight of the first hydrophobic polymer.

13. The method of claim 12, wherein the dichroic dye is present in an amount of about 0.5 to about 5 parts by weight based on 100 parts by weight of the first hydrophobic polymer.

14. The method of claim 8, wherein the ratio of the sum of the thicknesses of the first skin layer and the second skin layer, to the thickness of the core layer, is about 1:4 to about 4:1.

15. A display device comprising the polarizing film of claim 1.
